(19) United States
(12) Patent Application Publication
(10) Pub. No.: US 2025/0386137 A1
(43) Pub. Date: Dec. 18, 2025

(54) MICROPHONE CONTROL METHOD AND ELECTRONIC DEVICE

(71) Applicant: HONOR DEVICE CO., LTD., Shenzhen (CN)

(72) Inventors: Yingbo Zhang, Shenzhen (CN); Jun Zhou, Shenzhen (CN)

(21) Appl. No.: 18/881,177

(22) PCT Filed: Sep. 8, 2023
(86) PCT No.: PCT/CN2023/117846

§ 371 Date: Jan. 3, 2025

(30) Foreign Application Priority Data
Dec. 24, 2022 (CN) 202211668285.7

(51) Int. Cl. H04R 3/00; H04R 1/40

(52) U.S. Cl. CPC H04R 3/005; H04R 1/406; H04R 2201/401; H04R 2430/00

(57) ABSTRACT

When the electronic device is in a first pose, enabling a first array to collect first sound data, where the first array includes a first microphone and a second microphone in a plurality of microphones; and the starting a first array includes: establishing a connection between the first microphone and a first analog to digital converter, and establishing a connection between the second microphone and a second analog to digital converter; and when the electronic device is in a second pose, enabling a second array to collect second sound data, where the second array also includes a third microphone and a fourth microphone in the plurality of microphones; the starting a second array includes: establishing a connection between the third microphone and the first analog to digital converter, and establishing a connection between the fourth microphone and the second analog to digital converter.

This application claims priority to Chinese Patent Application No. 202211668285.7, filed with the China National Intellectual Property Administration on Dec. 24, 2022 and entitled “MICROPHONE CONTROL METHOD AND ELECTRONIC DEVICE”, which is incorporated herein by reference in its entirety.

### TECHNICAL FIELD

This application relates to the field of intelligent terminal technologies, and in particular, to a microphone control method and an electronic device.

### BACKGROUND

As device hardware is iteratively updated, various electronic devices can provide more high-quality services for users. Theoretically, a sound pickup range of the electronic device can be expanded by increasing a quantity of microphones connected to the electronic device.

However, the quantity of microphones that can be connected to the electronic device is limited by hardware conditions. Consequently, the sound pickup range of the electronic device is always limited.

### SUMMARY

Embodiments of this application provide a microphone control method and an electronic device, to widen a sound pickup range of the electronic device.

To achieve the foregoing objective, the following technical solutions are used in the embodiments of this application.

According to a first aspect, an embodiment of this application provides a microphone control method, applied to an electronic device. The electronic device includes a plurality of microphones, a first analog to digital converter, and a second analog to digital converter. The method includes:
when the electronic device is in a first pose, enabling a first array to collect first sound data, where the first array includes a first microphone and a second microphone in the plurality of microphones; and
for example, the starting the first array includes: establishing a connection between the first microphone and the first analog to digital converter, and establishing a connection between the second microphone and the second analog to digital converter; and
when the electronic device is in a second pose, enabling a second array to collect second sound data, where the second array also includes a third microphone and a fourth microphone in the plurality of microphones; and
for example, the starting the second array includes: establishing a connection between the third microphone and the first analog to digital converter, and establishing a connection between the fourth microphone and the second analog to digital converter; and the first pose is different from the second pose.

It may be understood that different microphones correspond to different sound pickup directions. The electronic device starts arrays including different microphones to collect sounds in different range areas. Clearly, a larger quantity of arrays that can be enabled by the electronic device indicates a wider sound pickup range.

In the foregoing embodiment, in different poses, the electronic device may enable different arrays to collect sound data, so as to complete sound pickup work in different ranges of content. In this way, an actual available sound pickup range of the electronic device is very large. In addition, when different arrays are enabled, only different microphones need to be connected to the analog to digital converter. That is, there is no longer a one-to-one correspondence between the analog to digital converter and the microphone. In this way, a quantity of analog to digital converters in the electronic device cannot limit a quantity of microphones connected to the electronic device, and the electronic device can further obtain more microphone arrays through combination, to widen a sound pickup range and meet different sound pickup requirements.

In some embodiments, before the starting the second array, the method further includes: disconnecting the connection between the first microphone and the first analog to digital converter; and disconnecting the connection between the second microphone and the second analog to digital converter.

In the foregoing embodiment, the connection between the analog to digital converter and the microphone may be established or disconnected. By controlling establishment and disconnection of the connection between the analog to digital converter and the microphone, switching of the enabled microphone array is implemented, to flexibly adjust the sound pickup range.

In some embodiments, before the enabling a first array to collect first sound data, the method further includes: collecting first pose information, where the first pose information indicates that the electronic device is in the first pose; and before the enabling a second array to collect second sound data, the method further includes: collecting second pose information, where the second pose information indicates that the electronic device is in the second pose.

In some embodiments, the method further includes: receiving a first operation performed by a user; and in response to the first operation, switching to enable a third array to collect third sound data, where the third array includes a fifth microphone and a sixth microphone in the plurality of microphones.

In the foregoing embodiment, the user may indicate to change the used microphone array, to meet a sound pickup requirement directly indicated by the user, and improve intelligence of switching the microphone array by the electronic device.

In an implementation, the first operation includes an operation of selecting the third array by the user, and before the receiving a first operation performed by a user, the method further includes: displaying a first interface, where location distribution of the plurality of microphones is displayed in the first interface; and detecting a selection operation performed by the user on the microphone in the first interface, where when the user selects the fifth microphone and the sixth microphone, it is determined that the first operation is received.

In this implementation, the user may directly select a microphone array that needs to be enabled. For example, before indicating the electronic device to enable sound pickup, the user may first specify a microphone array that participates in sound pickup, to ensure that a sound pickup result is close to a requirement of the user.

In some embodiments, the first operation is an operation of indicating a first direction, and in the electronic device, there is a correspondence between the third array and the first direction.

In some embodiments, before the receiving a first operation performed by a user, the method includes: displaying a second interface, where the second interface is an application interface of a conference service application, and the second interface includes a location distribution map of participants; and when it is detected that the user selects a first participant in the second interface and a direction between the first participant and the user is the first direction, determining that the first operation is received.

In some embodiments, the method further includes: detecting that a communication connection to a stylus is established; and switching to enable a fourth array to collect fourth sound data, where the fourth array includes a seventh microphone in the plurality of microphones and a microphone configured on the stylus.

In some embodiments, a first model is configured in the electronic device, the first model is a machine learning model used to identify a matching microphone array, and the method further includes: obtaining current scenario information, where the scenario information includes one or a combination of system time, a positioning location, a device battery level, and pose information; inputting the current scenario information to the first model, to determine a fifth array; and enabling the fifth array to collect fifth sound data.

In some embodiments, the electronic device includes a first list, and the first list records that the first array matches the first pose and also records that the second array matches the second pose.

According to a second aspect, an embodiment of this application provides an electronic device. The electronic device includes one or more processors and a memory. The memory is coupled to the processor. The memory is configured to store computer program code, and the computer program code includes computer instructions. When the one or more processors execute the computer instructions, the one or more processors are configured to:
when the electronic device is in a first pose, enable a first array to collect first sound data, where the first array includes a first microphone and a second microphone in the plurality of microphones; and the starting the first array includes: establishing a connection between the first microphone and a first analog to digital converter, and establishing a connection between the second microphone and a second analog to digital converter; and when the electronic device is in a second pose, enable a second array to collect second sound data, where the second array also includes a third microphone and a fourth microphone in the plurality of microphones; the starting the second array includes: establishing a connection between the third microphone and the first analog to digital converter, and establishing a connection between the fourth microphone and the second analog to digital converter; and the first pose is different from the second pose.

In some embodiments, the one or more processors are further configured to: disconnect the connection between the first microphone and the first analog to digital converter; and disconnect the connection between the second microphone and the second analog to digital converter.

In some embodiments, the one or more processors are further configured to: collect first pose information, where the first pose information indicates that the electronic device is in the first pose; and collect second pose information, where the second pose information indicates that the electronic device is in the second pose.

In some embodiments, the one or more processors are further configured to: receive a first operation performed by a user; and in response to the first operation, switch to enable a third array to collect third sound data, where the third array includes a fifth microphone and a sixth microphone in the plurality of microphones.

In some embodiments, the one or more processors are further configured to: display a first interface, where location distribution of the plurality of microphones is displayed in the first interface; and detect a selection operation performed by the user on the microphone in the first interface, where when the user selects the fifth microphone and the sixth microphone, it is determined that the first operation is received.

In some embodiments, the first operation is an operation of indicating a first direction, and in the electronic device, there is a correspondence between the third array and the first direction.

In some embodiments, the one or more processors are further configured to: display a second interface, where the second interface is an application interface of a conference service application, and the second interface includes a location distribution map of participants; and when it is detected that the user selects a first participant in the second interface and a direction between the first participant and the user is the first direction, determine that the first operation is received.

In some embodiments, the one or more processors are further configured to: detect that a communication connection to a stylus is established; and switch to enable a fourth array to collect fourth sound data, where the fourth array includes a seventh microphone in the plurality of microphones and a microphone configured on the stylus.

In some embodiments, the one or more processors are further configured to: obtain current scenario information, where the scenario information includes one or a combination of system time, a positioning location, a device battery level, and pose information; input the current scenario information to the first model, to determine a fifth array; and enable the fifth array to collect fifth sound data.

In some embodiments, the electronic device includes a first list, and the first list records that the first array matches the first pose and also records that the second array matches the second pose.

According to a third aspect, an embodiment of this application provides a computer storage medium, including computer instructions. When the computer instructions are run on an electronic device, the electronic device is enabled to perform the method according to the first aspect and the possible embodiments of the first aspect.

According to a fourth aspect, this application provides a computer program product. When the computer program product is run on the foregoing electronic device, the electronic device is enabled to perform the method according to the first aspect and the possible embodiments of the first aspect.

It may be understood that the electronic device, the computer storage medium, and the computer program product provided in the foregoing aspects are all applied to the corresponding method provided above. Therefore, for beneficial effects that can be achieved by the electronic device, the computer storage medium, and the computer program product, refer to the beneficial effects in the corresponding method provided above. Details are not described herein again.

### BRIEF DESCRIPTION OF DRAWINGS

FIG. 1 is an example diagram 1 of distribution of microphones in an electronic device (a tablet computer) according to an embodiment of this application;

FIG. 2 is an example diagram 2 of distribution of microphones in an electronic device (a tablet computer) according to an embodiment of this application;

FIG. 3 is an example diagram 1 of a hardware structure of an electronic device according to an embodiment of this application;

FIG. 4 is an example diagram 2 of a hardware structure of an electronic device according to an embodiment of this application;

FIG. 5 is an example diagram 3 of a hardware structure of an electronic device according to an embodiment of this application;

FIG. 6 is an example diagram 1 of microphone array switching according to an embodiment of this application;

FIG. 7 is an example diagram 2 of microphone array switching according to an embodiment of this application;

FIG. 8 is an example diagram 3 of microphone array switching according to an embodiment of this application;

FIG. 9 is an example diagram 1 of a sound pickup range corresponding to a microphone array according to an embodiment of this application;

FIG. 10 is an example diagram 2 of a sound pickup range corresponding to a microphone array according to an embodiment of this application;

FIG. 11 is an example diagram 1 of a selected collection direction according to an embodiment of this application;

FIG. 12 is an example diagram 2 of a selected collection direction according to an embodiment of this application;

FIG. 13 is an example diagram of a sound pickup range of a collaborative system including an electronic device and a stylus according to an embodiment of this application; and

FIG. 14 is an example diagram of a chip system according to an embodiment of this application.

### DESCRIPTION OF EMBODIMENTS

In the following, the terms “first” and “second” are used merely for the purpose of description, and shall not be construed as indicating or implying relative importance or implicitly indicating a quantity of indicated technical features. Therefore, a feature limited by “first” or “second” may explicitly or implicitly include one or more features. In the descriptions of the embodiments, unless otherwise stated, “a plurality of” means two or more.

With development of technologies, hardware resources (for example, a storage resource, a computing resource, and an input/output resource) configured in various electronic devices are continuously iterated and upgraded, to provide higher-quality services for users.

An audio collection module (for example, a microphone) in the electronic device is used as an example. As the audio collection module is continuously iterated and upgraded, quality of an audio collection service provided by the electronic device improves.

In some embodiments, the audio collection module in the electronic device may be upgraded by increasing a quantity of microphones. For example, a microphone configured on a body of the electronic device is upgraded from a single microphone to four microphones, or is upgraded to eight microphones. In this way, more sound pickup angles can be added by using more microphones, and a sound pickup range of the electronic device can be effectively expanded.

In some embodiments, microphones in the electronic device may have different sound pickup directions when being deployed at different locations. For example, microphones configured on different side edges of the electronic device correspond to different sound pickup directions. Certainly, there is also a case in which some microphones correspond to different deployment locations, but sound pickup directions are the same. For example, microphones configured on a same side edge of the electronic device have different deployment locations, but corresponding sound pickup directions are the same.

In some embodiments, the electronic device may be an intelligent electronic device, for example, a mobile phone, a tablet computer, a handheld computer, a PC, a cellular phone, a personal digital assistant (personal digital assistant, PDA), a wearable device (for example, a smartwatch), a smart large screen, a game console, and an augmented reality (augmented reality, AR)/virtual reality (virtual reality, VR) device. In subsequent embodiments, an example in which the electronic device is a tablet computer is mainly used as an example.

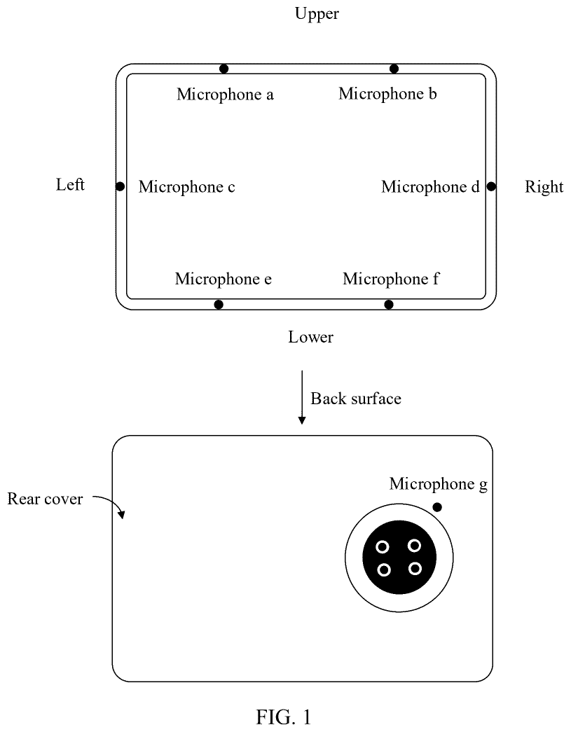

For example, the electronic device is a tablet computer, and a body of the tablet computer includes four side edges. A microphone in the tablet computer may be deployed on the four side edges. For example, one or more microphones may be configured on each side edge. As shown in FIG. 1, a microphone a and a microphone b may be configured on an upper side edge, a microphone e and a microphone f may be configured on a lower side edge, a microphone c may be configured on a left side edge of the tablet computer, and a microphone d may be configured on a right side edge of the tablet computer.

For another example, at least one microphone is configured on some side edges, and no microphone is configured on some side edges. For example, at least one microphone is configured on each of an upper side edge, a left side edge, and a right side edge, and no microphone is configured on a lower side edge.

In addition, as shown in FIG. 1, the body of the tablet computer further includes a rear cover, and the rear cover is disposed opposite to a display. Usually, the rear cover may be used to configure a rear-facing camera of the tablet computer. In some examples, a microphone may also be configured on the rear cover of the tablet computer. For example, at least one microphone may be configured on a side of the rear-facing camera of the tablet computer.

In some embodiments, the tablet computer may collect, through the microphone installed on the body, sounds emitted by sound sources in different directions.

For example, in a landscape state of the tablet computer, the microphone configured on the upper side edge is configured to pick up a sound emitted by a sound source located above the tablet computer, the microphone configured on the lower side edge is configured to pick up a sound emitted by a sound source located below the tablet computer, the microphone configured on the rear cover is configured to pick up a sound emitted by a sound source located in front of the tablet computer, the microphone configured on the left side edge is configured to pick up a sound emitted by a sound source located on a left side of the tablet computer, and the microphone configured on the right side edge is configured to pick up a sound emitted by a sound source located on a right side of the tablet computer.

Certainly, a sound pickup direction of each microphone may change. For example, when a posture of the tablet computer in space changes, the sound pickup direction of each microphone also correspondingly changes.

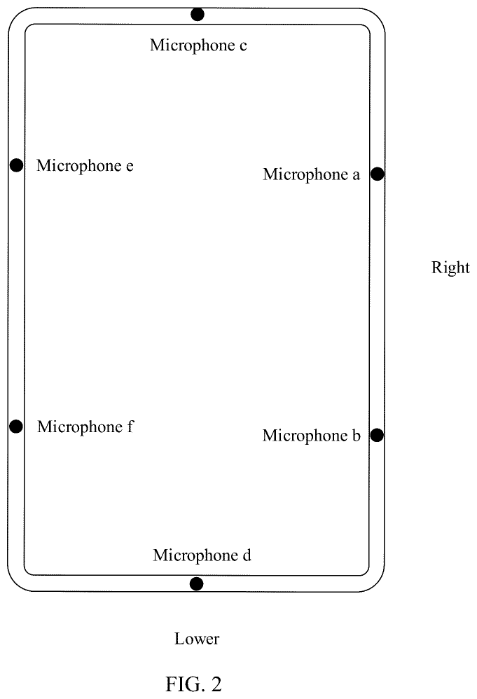

For example, when the tablet computer rotates to the right to a portrait state, as shown in FIG. 2, the microphone a and the microphone b that are configured on the original upper side edge are configured to pick up a sound emitted by a sound source located on the right side of the tablet computer, the microphone e and the microphone f that are configured on the original lower side edge are configured to pick up a sound emitted by a sound source located on the left side of the tablet computer, the microphone g configured on the rear cover is configured to pick up a sound emitted by a sound source located in front of the tablet computer, the microphone c configured on the original left side edge is configured to pick up a sound emitted by a sound source located above the tablet computer, and the microphone d configured on the right side edge is configured to pick up a sound emitted by a sound source located below the tablet computer.

For another example, when the tablet computer rotates to the left to a portrait state, the microphone a and the microphone b that are configured on the original upper side edge are configured to pick up a sound emitted by a sound source located on the left side of the tablet computer, the microphone e and the microphone f that are configured on the original lower side edge are configured to pick up a sound emitted by a sound source located on the right side of the tablet computer, the microphone g configured on the rear cover is configured to pick up a sound emitted by a sound source located in front of the tablet computer, the microphone c configured on the original left side edge is configured to pick up a sound emitted by a sound source located below the tablet computer, and the microphone d configured on the right side edge is configured to pick up a sound emitted by a sound source located above the tablet computer.

It should be noted that “upper”, “lower”, “left”, and “right” may be directions determined by using a housing of the tablet computer as a reference. For example, when the tablet computer is a rectangle, two relatively short edges on the housing of the tablet computer are respectively the left side edge and the right side edge, and two relatively long edges are respectively the upper side edge and the lower side edge.

In addition, in addition to collecting sound data through the microphone configured on the body, the electronic device may further collect sound data through a third-party device (for example, a headset or a stylus). For example, after the third-party device establishes a communication connection to the electronic device, a microphone of the third-party device may collect a sound. Then, the third-party device may send collected sound data to the electronic device. Clearly, the microphone of the third-party device may additionally add a sound pickup direction to the electronic device. Certainly, sound pickup directions provided by some third-party devices are relatively more variable. For example, the stylus provides different sound pickup directions at different angles. Sound pickup directions provided by some third-party devices are relatively fixed. For example, when a user wears a headset, a sound pickup direction provided by the headset is relatively fixed.

In an ideal case, a larger quantity of microphones that can be connected to the electronic device indicates a corresponding wider sound pickup range. In this way, it is more likely that a high-quality sound pickup service (for example, a recording service) can be provided for the user. However, in an actual case, a quantity of microphones (including the microphone of the third-party device) that can be connected to the electronic device is limited.

It may be understood that analog to digital conversion needs to be performed, by using an analog to digital converter (analog to digital converter, ADC), on sound data (for example, a sound wave signal) collected by the microphone, and sound data obtained after analog to digital conversion is data that can be identified and continue to be processed by the electronic device. After completing analog to digital conversion on the sound data, the analog to digital converter may transfer the sound data to a digital codec (Codec Digital). In this way, the sound data collected by the microphone can be encoded and compressed, and sound data obtained after encoding and compression can participate in a subsequent service, for example, storage and transmission.

However, due to a limitation of a device chip, a quantity of analog to digital converters in the electronic device is limited. In addition, the microphone needs to be in a one-to-one correspondence with the analog to digital converter. In this case, the quantity of microphones that can be connected to the electronic device is limited. For example, when there are only three analog to digital converters in the electronic device, the quantity of microphones that can be connected to the electronic device cannot exceed three. If one analog to digital converter further needs to be reserved for the microphone of the third-party device, no more than two microphones can be configured on a body of the electronic device. Otherwise, there is a microphone that cannot be normally.

The embodiments of this application provide a microphone control method, applied to an electronic device. Without increasing a quantity of analog to digital converters in the electronic device, a microphone connected to the analog to digital converter is dynamically switched, and by using a characteristic that different microphones have different sound pickup directions, different microphone arrays (including a plurality of microphones) or different single microphones are used to pick up sounds in different range areas. In this way, the analog to digital converter no longer limits a quantity of microphones that can be connected to the electronic device.

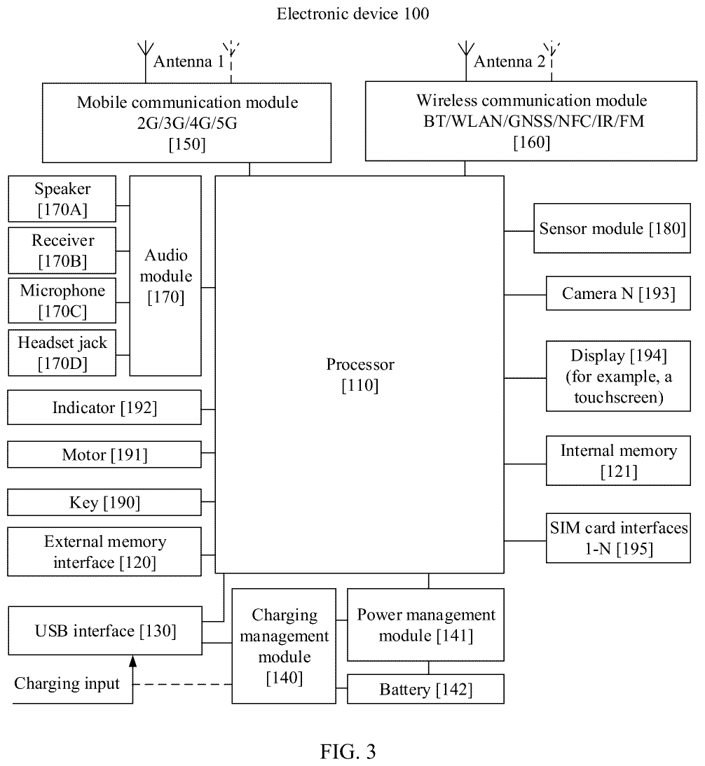

FIG. 3 is a schematic diagram of a structure of an electronic device 100 according to an embodiment of this application.

As shown in FIG. 3, the electronic device 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a key 190, a motor 191, an indicator 192, a camera 193, a display 194, a subscriber identification module (subscriber identification module, SIM) card interface 195, and the like.

The sensor module 180 may include sensors such as a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, and a bone conduction sensor.

It may be understood that the structure shown in this embodiment does not constitute a specific limitation on the electronic device 100. In some other embodiments, the electronic device 100 may include more or fewer components than those shown in the figure, combine some components, split some components, or have different component arrangements. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, and/or a neural-network processing unit (neural-network processing unit, NPU). Different processing units may be independent devices, or may be integrated into one or more processors.

The controller may be a nerve center and command center of the electronic device 100. The controller may generate an operation control signal based on instruction operation code and a timing signal, to complete control of instruction fetching and instruction execution.

A memory may be further disposed in the processor 110 to store instructions and data. In some embodiments, the memory in the processor 110 is a cache. The memory may store instructions or data just used or cyclically used by the processor 110. If the processor 110 needs to use the instructions or the data again, the processor 110 may directly invoke the instructions or the data from the memory. This avoids repeated access and reduces waiting time of the processor 110, thereby improving system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identification module (subscriber identity module, SIM) interface, a universal serial bus (universal serial bus, USB) interface, and/or the like.

It may be understood that an interface connection relationship between the modules illustrated in this embodiment is merely an example for description, and does not constitute a limitation on the structure of the electronic device 100. In some other embodiments, the electronic device 100 may alternatively use an interface connection manner different from that in the foregoing embodiment, or use a combination of a plurality of interface connection manners.

The electronic device 100 implements a display function by using the GPU, the display 194, the application processor, and the like. The GPU is a microprocessor for image processing and is connected to the display 194 and the application processor. The GPU is configured to perform mathematical and geometric computing for graphics rendering. The processor 110 may include one or more GPUs that execute program instructions to generate or change displayed information.

The external memory interface 120 may be configured to be connected to an external memory card, for example, a Micro SD card, to expand a storage capability of the electronic device 100. The external memory card communicates with the processor 110 through the external memory interface 120, to implement a data storage function. For example, files such as music and videos are stored in the external memory card.

The internal memory 121 may be configured to store computer-executable program code, and the executable program code includes instructions. The internal memory 121 may include a program storage area and a data storage area. The program storage area may store an operating system, an application required by at least one function (for example, a sound playing function and an image playing function), and the like. The data storage area may store data (for example, audio data and a phone book) and the like created during use of the electronic device 100. In addition, the internal memory 121 may include a high-speed random access memory, and may further include a nonvolatile memory, for example, at least one magnetic disk storage device, a flash memory device, or a universal flash storage (universal flash storage, UFS). The processor 110 performs various function applications and data processing of the electronic device 100 by running the instructions stored in the internal memory 121 and/or instructions stored in the memory disposed in the processor.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flex light-emitting diode, FLED), a Miniled, a MicroLed, a Micro-oLed, a quantum dot light emitting diode (quantum dot light emitting diodes, QLED), or the like.

The electronic device 100 may implement a shooting function by using the ISP, the camera 193, the video codec, the GPU, the display 194, the application processor, and the like.

The ISP is configured to process data fed back by the camera 193. For example, during photographing, a shutter is opened, and light is transferred to a photosensitive element of the camera through a lens. An optical signal is converted into an electrical signal. The photosensitive element of the camera transfers the electrical signal to the ISP for processing, to convert the electrical signal into an image visible to naked eyes. The ISP may further perform algorithm optimization on noise, brightness, and complexion of the image. The ISP may further optimize parameters such as exposure and a color temperature of a shooting scene. In some embodiments, the ISP may be disposed in the camera 193.

The camera 193 is configured to capture a still image or a video. An optical image of an object is generated through the lens and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transfers the electrical signal to the ISP to convert the electrical signal into a digital image signal. The ISP outputs the digital image signal to the DSP for processing. The DSP converts the digital image signal into an image signal in a standard format, for example, RGB or YUV. In some embodiments, the electronic device 100 may include N cameras 193, where Nis a positive integer greater than 1.

The digital signal processor is configured to process a digital signal, and may further process another digital signal in addition to the digital image signal. For example, when the electronic device 100 selects a frequency, the digital signal processor is configured to perform Fourier transform and the like on frequency energy.

The video codec is configured to compress or decompress a digital video. The electronic device 100 may support one or more video codecs. In this way, the electronic device 100 may play or record videos in a plurality of encoding formats, for example, moving picture experts group (moving picture experts group, MPEG) 1, MPEG2, MPEG3, and MPEG4.

The NPU is a neural-network (neural-network, NN) computing processor, which quickly processes input information by referring to a biological neural network structure, for example, by referring to a transmission mode between human brain neurons, and may further perform self-learning continuously. Applications such as intelligent cognition of the electronic device 100, for example, image recognition, face recognition, voice recognition, and text understanding, may be implemented by using the NPU.

The microphone 170C may be configured to collect a sound in an environment. In this embodiment of this application, a plurality of microphones 170C may be included, and the plurality of microphones 170C may have different arrangement locations or installation locations on the electronic device. For example, FIG. 1 is an example diagram of arranging a microphone 170C in an electronic device. Certainly, more or fewer microphones may be installed in the electronic device. Similarly, the microphone may be arranged in another manner in the electronic device.

In some embodiments, the electronic device may include a digital codec, an ADC, and a plurality of microphones.

In some embodiments, the digital codec is connected to the ADC. The ADC can establish a connection to the microphone, and may be disconnected from the microphone. In a same time period, a single ADC may establish a connection only to a single microphone. In different time periods, the ADC may establish a connection to different microphones.

After a connection between the ADC and the microphone is established, the ADC may perform analog to digital conversion processing on sound data collected by the microphone. Sound data obtained after the ADC performs mode conversion processing may also be sent to the digital codec, and the digital codec performs processing such as encoding and compression.

In some other embodiments, a connection may be established between the ADC and the microphone through a bias circuit. That is, the electronic device may further include a plurality of bias circuits. The bias circuit is connected to the microphone, and the bias circuit may further establish a connection to the ADC. When a connection is established between the bias circuit and the ADC, sound data collected by the microphone needs to be first processed by the bias voltage, and then transferred to the ADC, and the ADC performs analog to digital conversion processing. For a working principle of the bias circuit, refer to a related technology. Details are not described herein.

In addition, when the bias circuit may establish a connection to the ADC, the connection between the bias circuit and the ADC may be disconnected. In this way, by controlling the connection and disconnection between the bias circuit and the ADC, the ADC can establish a connection to different microphones in different time periods.

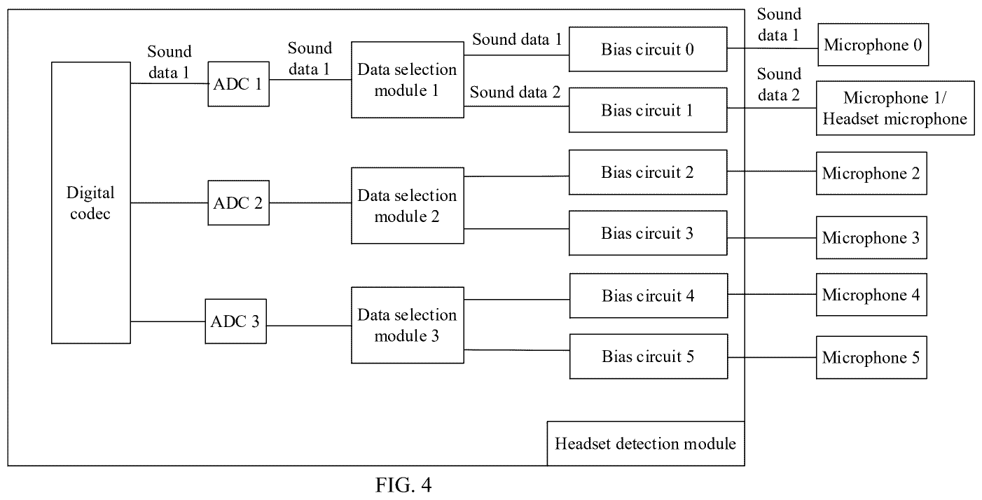

In some examples, a fixed connection relationship is established between a microphone and a bias circuit. For example, as shown in FIG. 4, there is a bias circuit 0, a bias circuit 2, a bias circuit 3, a bias circuit 4, and a bias circuit 5. A connection is established between the bias circuit 0 and a microphone 0, and the bias circuit 0 may receive sound data collected by the microphone 0; a connection is established between the bias circuit 2 and a microphone 2, and the bias circuit 2 may receive sound data collected by the microphone 2; and so on. In addition, the microphone 0 may be a microphone from a stylus (a third-party device). The microphone 2, a microphone 3, a microphone 4, and a microphone 5 may be microphones installed on a body of the electronic device.

In some other examples, the plurality of microphones may share a same bias circuit. When the plurality of microphones share a same bias circuit, only one microphone may be connected to the bias circuit in a same time period. For example, a bias circuit 1 shown in FIG. 4 may establish a connection to a microphone 1 (one of microphones configured on a body of the electronic device) or a microphone of a headset (a third-party device). That is, the microphone 1 and the microphone of the headset need to share the bias circuit 1. In some examples, when the electronic device is connected to the headset, the microphone of the headset establishes a connection to the bias circuit 1; and when the electronic device is not connected to the headset, the microphone 1 establishes a connection to the bias circuit 1.

In some examples, the electronic device further includes a headset detection module, and the headset detection module may be configured to detect whether the electronic device is connected to a headset. For example, the headset detection module may include an ACCDET module. For a principle of detecting, by the ACCDET module, whether a headset is connected, refer to a related technology. Details are not described herein.

In addition, when it is detected that a headset is connected to the electronic device, the bias circuit 1 is connected to a microphone of the headset. In this case, the bias circuit 1 receives only sound data collected by the microphone of the headset. When it is not detected that a headset is connected to the electronic device, the bias circuit 1 is connected to the microphone 1. In this case, the bias circuit 1 may receive sound data collected by the microphone 1.

In some other embodiments, the connection between the ADC and the microphone (or the bias circuit) may be established or disconnected by using a data selection module.

In some examples, the data selection module may be a PGA-MUX device. In this way, one data selection module may establish a connection to one ADC.

In this example, if a quantity of ADCs in the electronic device is the same as a quantity of data selection modules, the ADC is in a one-to-one correspondence with the data selection module. For example, as shown in FIG. 4, the electronic device includes an ADC 1, an ADC 2, an ADC 3, a data selection module 1, a data selection module 2, and a data selection module 3. The ADC 1 uniquely corresponds to the data selection module 1, the ADC 2 uniquely corresponds to the data selection module 2, and the ADC 3 uniquely corresponds to the data selection module 3.

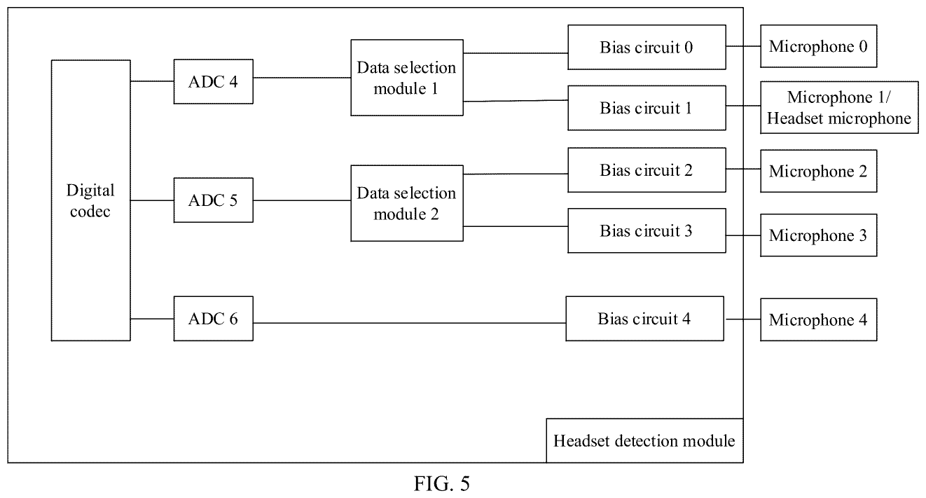

In this example, if a quantity of ADCs in the electronic device is different from a quantity of data selection modules, that is, when the quantity of data selection modules may be less than the quantity of ADCs, each data selection module is connected to one ADC, but there is an ADC connected to no data selection module. For example, as shown in FIG. 5, the electronic device includes an ADC 4, an ADC 5, an ADC 6, a data selection module 1, and a data selection module 2. The ADC 4 is connected to the data selection module 1, the ADC 5 is connected to the data selection module 2, and the ADC 6 is connected to no data selection module.

In some embodiments, in addition to being connected to the ADC, the data selection module can further establish a connection to at least one microphone, for example, establish a connection to the microphone through the bias circuit. It may be understood that the data selection module is a switch-like device, and can not only establish a connection to the microphone, but also disconnect the connection to the microphone.

When the data selection module can establish a connection to a plurality of microphones, only one microphone can be connected to the data selection module in a same time period, and in different time periods, the data selection module may choose to establish a connection to different microphones.

In this way, after a connection between the data selection module and the selected microphone is established, for example, after a connection to a bias circuit corresponding to the selected microphone is established, sound data collected by the microphone is processed by the bias circuit and then may be transferred to a corresponding ADC by using the data selection module.

For example, as shown in FIG. 4, when the data selection module 1 may choose to establish a connection to the microphone 0 from the microphone 0 and the microphone 1, the data selection module 1 may receive sound data 1 (sound data collected by the microphone 0) obtained after processing by the bias circuit 0, and transfer the sound data 1 to the ADC 1. It may be learned that after the data selection module 1 establishes a connection to the microphone 0, it is equivalent to that a data transmission channel between the microphone 0 and the ADC 1 is established. In this case, the sound data collected by the microphone 0 may be normally transferred to the ADC 1, and the ADC 1 performs analog to digital conversion. Then, the ADC 1 may transfer sound data obtained after analog to digital conversion to the digital codec, and the digital codec performs processing such as encoding and compression. That is, the electronic device may normally enable the microphone 0, but cannot enable the microphone 1.

Certainly, between the microphone 0 and the microphone 1, the data selection module 1 may choose to disconnect the connection to the microphone 0 and establish a connection to the microphone 1. In this way, the data selection module 1 may receive sound data 2 (sound data collected by the microphone 1) obtained after processing by the bias circuit 1, and transfer the sound data 2 to the ADC 1. It may be learned that after the data selection module 1 establishes a connection to the microphone 1, it is equivalent to that a data transmission channel between the microphone 1 and the ADC 1 is established, and the data transmission channel between the microphone 0 and the ADC 1 is disconnected. In this case, the sound data collected by the microphone 1 may be normally transferred to the ADC 1, and the ADC 1 performs analog to digital conversion. Then, the ADC 1 may transfer sound data obtained after analog to digital conversion to the digital codec, and the digital codec performs processing such as encoding and compression. That is, the electronic device may normally enable the microphone 1, but cannot enable the microphone 0.

Similarly, the data selection module 2 in FIG. 4 may choose, by establishing a connection between the ADC 2 and the microphone 2 or establishing a connection between the ADC 2 and the microphone 3, to enable the microphone 2 or enable the microphone 3, and the data selection module 3 in FIG. 4 may choose, by establishing a connection between the ADC 3 and the microphone 4 or establishing a connection between the ADC 3 and the microphone 5, to enable the microphone 4 or enable the microphone 5.

It may be learned that when there are also only three ADCs, the electronic device provided in this embodiment of this application may be connected to six microphones (including a microphone of a third-party device), and certainly, may be further connected to more microphones. For example, when a single data selection module may select one of three microphones to establish a connection, a total of nine microphones may be connected to the electronic device. In addition, all microphones connected to the electronic device may be normally used.

It may be understood that in a same time period, a same ADC can establish a connection only to one microphone. Only when a connection is established between the ADC and the microphone, the ADC can receive sound data collected by the microphone. In addition, in different time periods, the electronic device may change, by using the data selection module, the microphone connected to the ADC.

That is, in this embodiment of this application, by using the data selection module, the electronic device can dynamically switch the microphone connected to the ADC. For ease of description, “switching of the microphone connected to the ADC” is subsequently briefly referred to as switching for the ADC.

In some embodiments, the electronic device may enable at least one microphone to collect a sound, and a connection between the enabled microphone and the ADC is established. Microphones connected to different ADCs can simultaneously normally work, without affecting each other. When a plurality of microphones are simultaneously enabled, it may be considered that the electronic device enables a microphone array.

In addition, the electronic device may enable different microphone arrays by performing switching for at least one ADC.

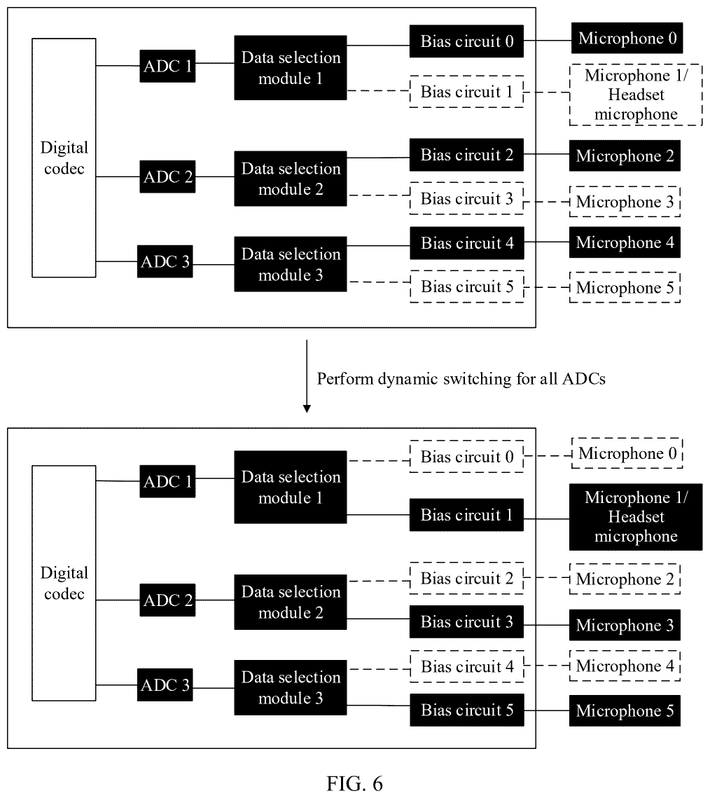

For example, as shown in FIG. 6, a connection is established between the ADC 1 and the microphone 0 in the electronic device, a connection is established between the ADC 2 and the microphone 2 in the electronic device, and a connection is established between the ADC 3 and the microphone 4 in the electronic device. In this case, the electronic device may enable a microphone array including the microphone 0, the microphone 2, and the microphone 4 to collect a sound.

After dynamic switching is performed for all ADCs, the ADC 1 in the electronic device may be switched to be connected to the microphone 1, the ADC 2 may be switched to be connected to the microphone 3, and the ADC 3 may be switched to be connected to the microphone 5. In this case, the electronic device enables a microphone array including the microphone 1, the microphone 3, and the microphone 5 to collect a sound.

In addition, when dynamic switching is performed only for the ADC 1, the electronic device may switch to enable a microphone array including the microphone 1, the microphone 2, and the microphone 4; when dynamic switching is performed only for the ADC 2, the electronic device may switch to enable a microphone array including the microphone 0, the microphone 3, and the microphone 4; when dynamic switching is performed only for the ADC 3, the electronic device may switch to enable a microphone array including the microphone 0, the microphone 2, and the microphone 5; when dynamic switching is performed for the ADC 1 and the ADC 2, the electronic device may switch to enable a microphone array including the microphone 1, the microphone 3, and the microphone 4; and so on.

Certainly, the electronic device may further include an ADC for which dynamic switching cannot be performed, for example, the ADC 6 in FIG. 5. As shown in FIG. 5, the ADC 6 has no corresponding data selection module, and the ADC 6 can be fixedly connected only to the bias circuit 4. That is, the ADC 6 can communicate only with the bias circuit 4, and can receive and process sound data (sound data collected by the microphone 4) sent only by the bias circuit 4. That is, unlike the ADC 4 and the ADC 5 in FIG. 5, the ADC 6 cannot switch a microphone connected to the ADC 6.

In some other examples, the data selection module may be an analog circuit with a selection function. For example, the analog circuit may select N microphones from M microphones, where M is a positive integer greater than N, M may be a quantity of microphones connected to the electronic device, and N may be a quantity of ADCs in the electronic device.

In this example, the data selection module may be connected to all ADCs. In addition, the data selection module may select a specified quantity of microphones from microphones connected to the electronic device, and establish a connection.

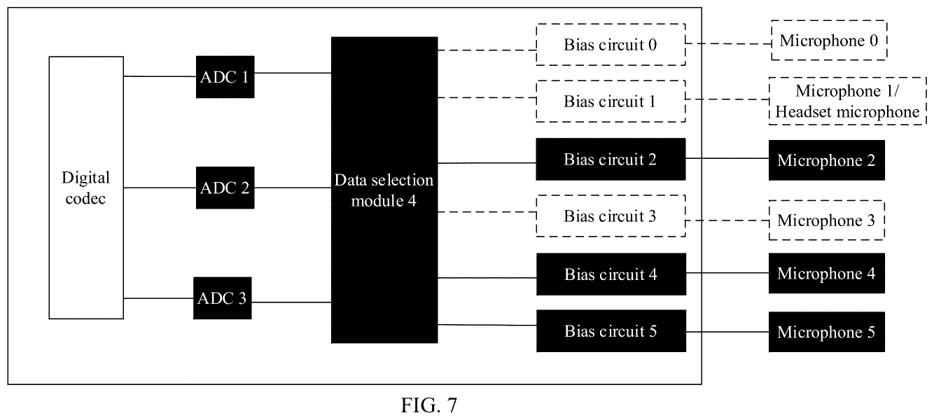

As shown in FIG. 7, the electronic device includes an ADC 1, an ADC 2, an ADC 3, and a data selection module 4. The data selection module 4 may establish a connection to all of the ADC 1, the ADC 2, and the ADC 3. In this way, the data selection module 4 may send different data to the ADC 1, the ADC 2, and the ADC 3 in parallel. In addition, the data selection module 4 has a capability of establishing a connection to each microphone, and certainly, has a capability of disconnecting the connection to the microphone.

On this basis, the data selection module 4 may select three microphones from the microphones connected to the electronic device, and establish a connection. In this way, the data selection module 4 may respectively send three pieces of sound data collected by the three microphones to the ADC 1, the ADC 2, and the ADC 3. For example, if the microphone 2, the microphone 4, and the microphone 5 are selected, the data selection module 4 may transfer sound data collected by the microphone 2 to the ADC 1, transfer sound data collected by the microphone 4 to the ADC 2, and transfer sound data collected by the microphone 5 to the ADC 3.

It is equivalent to that the data selection module 4 establishes a connection between the microphone 2 and the ADC 1, establishes a connection between the microphone 4 and the ADC 2, and establishes a connection between the microphone 5 and the ADC 3. In this way, the electronic device can normally enable the microphone 2, the microphone 4, and the microphone 5 to execute a sound collection task, and does not enable the microphone 0, the microphone 1, and the microphone 3. In this case, the electronic device enables a microphone array including the microphone 2, the microphone 4, and the microphone 5.

In some embodiments, the electronic device may further indicate the data selection module 4 to choose to establish a connection to different microphones. In this way, different microphone arrays can be obtained through combination.

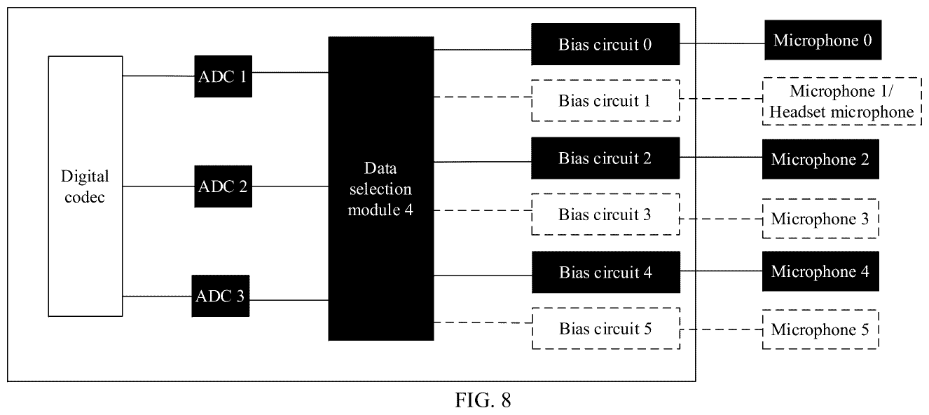

For example, if the data selection module 4 reselects the microphone 0, the microphone 2, and the microphone 4 to establish a connection, as shown in FIG. 8, it is equivalent to that the data selection module 4 establishes a connection between the microphone 0 and the ADC 1, establishes a connection between the microphone 2 and the ADC 2, and establishes a connection between the microphone 4 and the ADC 3. In this way, the electronic device can normally enable the microphone 0, the microphone 2, and the microphone 4, and does not enable the microphone 1, the microphone 3, and the microphone 5. In this case, the electronic device switches to enable a microphone array including the microphone 0, the microphone 2, and the microphone 4.

In addition, as described in the foregoing embodiment, a connection is established between the data selection module and the microphone, and in addition to establishing a direct connection between the data selection module and the microphone, a connection may be established by using the bias circuit. For example, after the data selection module establishes a connection to the bias circuit 0, because there is also a connection between the bias circuit 0 and the microphone 0, it may be considered that the data selection module establishes a connection to the microphone 0 through the bias circuit 0.

In conclusion, the electronic device provided in this embodiment of this application may dynamically switch an enabled microphone array. It may be understood that different microphone arrays may collect sounds in different range areas in an environment in which the electronic device is located.

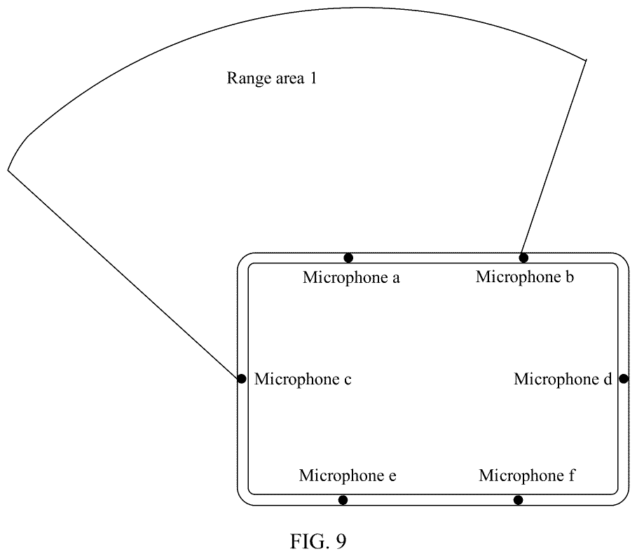

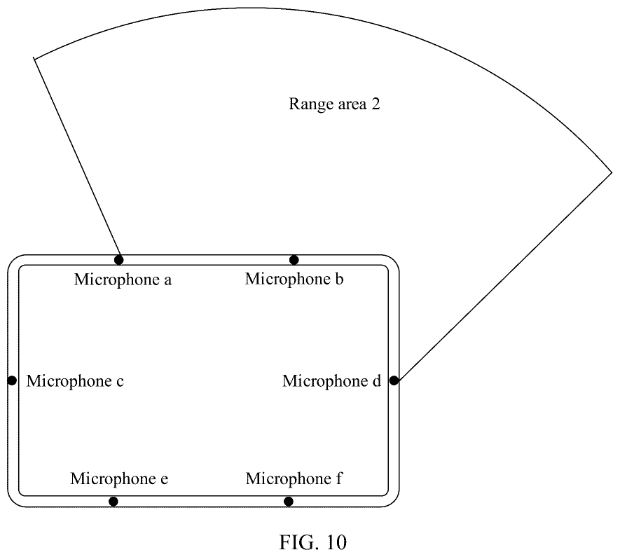

For example, as shown in FIG. 9, when enabling a microphone array including a microphone c, a microphone a, and a microphone b, the electronic device may pick up a sound in a range area 1. For another example, as shown in FIG. 10, when enabling a microphone array including a microphone a, a microphone b, and a microphone d, the electronic device may pick up a sound in a range area 2.

In some embodiments, the electronic device may intelligently enable different microphone arrays to meet different sound pickup requirements of the user. When determining a microphone array that needs to be used, the electronic device may use any one of the following manners:

In a first manner, the electronic device may determine an adapted microphone array based on detected pose information.

The pose information may indicate a posture of the electronic device in space. For example, the posture may include being parallel to a horizontal plane in a landscape state (for example, which is briefly referred to as a pose 1), forming an included angle less than an angle 1 (for example, 90 degrees) with a horizontal plane in a landscape state (for example, which is briefly referred to as a pose 2), forming an included angle not less than an angle 1 with a horizontal plane in a landscape state (for example, which is briefly referred to as a pose 3), or the like. For another example, the posture further includes being parallel to a horizontal plane in a portrait state (for example, which is briefly referred to as a pose 4), forming an included angle less than an angle 1 (for example, 90 degrees) with a horizontal plane in a portrait state (for example, which is briefly referred to as a pose 5), forming an included angle not less than an angle 1 with a horizontal plane in a portrait state (for example, which is briefly referred to as a pose 6), or another posture.

In some embodiments, the electronic device may periodically determine the pose information corresponding to the electronic device. For example, every other minute, the electronic device may determine the pose information of the electronic device based on data collected by a gyroscope, a gravity sensor, an acceleration sensor, or the like. For a specific implementation process, refer to a related technology. Details are not described herein.

In some other embodiments, the electronic device may determine the pose information corresponding to the electronic device in response to a specific event.

For example, the specific event may be enabling a specified application, for example, a recording application, a conference application, or a voice call application that needs to enable the microphone. For another example, the specific event may alternatively be receiving a specific indication, for example, an indication indicating to enable a sound collection function. For still another example, the specific event may alternatively be detecting that the enabled microphone array does not meet a condition for continued use. For example, when it is detected that some microphones in the enabled microphone array are blocked, the electronic device may determine that the microphone array does not meet the condition for continued use.

In this way, the electronic device can determine a current pose of the electronic device by using the collected pose information, and then select, based on the current pose, a microphone array that needs to be currently actually enabled.

In an implementation, a correspondence table a between different poses and different microphone arrays may be preconfigured in the electronic device. For example, when the electronic device is the tablet computer shown in FIG. 1, and the tablet computer includes only three ADCs, the correspondence table a between the pose and the microphone array may be shown in Table 1 below:

TABLE 1

| Pose | Microphone array |
|---|---|
| Pose 1 | Array combining the microphone a, the microphone b, and the |
| | microphone c |
| | Array combining the microphone a, the microphone b, and the |
| | microphone d |
| | Array combining a microphone e, a microphone f, and the |
| | microphone c |
| | Array combining the microphone e, the microphone f, and the |
| | microphone d |
| Pose 2 | Array combining the microphone a, the microphone b, and a |
| | microphone g |
| | Array combining the microphone e, the microphone f, and the |
| | microphone g |
| Pose 3 | Array combining the microphone b, the microphone d, and the |
| | microphone g |
| Pose 4 | Array combining the microphone a and the microphone c |
| | Array combining the microphone d and the microphone f |
| Pose 5 | Array including the microphone c and the microphone g |
| | Array including the microphone d and the microphone g |
| Pose 6 | Array combining the microphone a, the microphone b, and the |
| | microphone g |
| | Array combining the microphone e, the microphone f, and the |
| | microphone g |

It may be understood that Table 1 is merely an example of a correspondence, and does not constitute a limitation on this embodiment of this application. Certainly, it may be learned from Table 1 that a single pose may correspond to one or more groups of microphone arrays, and a quantity of microphones in each group of microphone arrays does not exceed a total quantity of ADCs. Microphones in a same group correspond to different ADCs. In this way, the microphones in the same group can normally work, that is, collected sound data can be transferred in parallel to the digital codec, and the digital codec performs processing such as encoding and compression.

In addition, it should be noted that in addition to enabling the microphone array to collect sound data, the electronic device may further enable a single microphone to collect sound data. Similarly, the electronic device may preconfigure single microphones that are most suitable for collecting a sound in different poses. In this way, the electronic device can switch, based on different pose information, to enable different single microphones to collect a sound. In subsequent embodiments, determining logic and a method related to the microphone array are also applicable to the single microphone. Details are not described again in the subsequent embodiments.

In addition, a quantity and types of poses may be set based on an empirical value. A correspondence between different poses and microphone arrays may be obtained through testing. For example, in each pose, sound pickup effects corresponding to all microphone arrays that can be enabled are tested. The sound pickup effect may be distinguished by using a sound effect score. The sound effect score may be a score given by an artificial intelligence model for collected sound data from perspectives of sound quality, volume, and the like. Then, a microphone array whose sound pickup effect has a higher ranking than a specified ranking is selected as a microphone array corresponding to the pose, and the correspondence table a is formed.

When the correspondence table a is configured in the electronic device, the electronic device may query, by using the comparison relationship table a, a microphone array that matches the current pose, and enable the microphone array. For example, if it is determined, based on the collected pose information, that the current pose of the electronic device is the pose 3, it may be obtained, through query by using Table 1, that a matching microphone array includes the microphone b, the microphone d, and the microphone g. In this scenario, the electronic device may use the microphone array obtained through query as the microphone array that needs to be actually enabled.

In addition, the microphone array may be enabled in the following manner: A connection between each microphone in the microphone array and a corresponding ADC is established. Then, sound data collected by each microphone in the microphone array is processed by a corresponding bias circuit, and then is transferred to the corresponding ADC through a data selection module. After completing analog to digital conversion on the sound data, the corresponding ADC sends the sound data to the digital codec, and the digital codec performs processing such as encoding and compression on the sound data. In this way, the microphone array is normally run.

Certainly, if there is no data selection module between the microphone in the microphone array and the ADC, the sound data collected by the microphone is processed by the bias circuit, and then is directly sent to the corresponding ADC, the corresponding ADC performs analog to digital conversion on the sound data, and finally, the digital codec encodes and compresses the sound data. For example, for the ADC 6 and the microphone 4 in FIG. 5, when the microphone array includes the microphone 4, sound data collected by the microphone 4 is processed by the bias circuit 4, and then is directly sent to the ADC 6, and the ADC 6 performs analog to digital conversion processing.

In addition, in some special cases, for example, when a plurality of matching microphone arrays are obtained through query, one of the plurality of matching microphone arrays may be selected as the microphone array to be actually enabled.

For example, selection may be performed in a random manner. That is, the electronic device may select one microphone array as the microphone array to be currently actually enabled from the plurality of matching microphone arrays by using a preconfigured random algorithm.

For another example, a microphone array that meets a preset condition may be selected.

For example, the preset condition may include being marked with a “commonly used” label by the user. In some examples, the electronic device may display an example distribution map of microphones on the electronic device in advance. During display of the example distribution map, the user may select a commonly used microphone, and the electronic device may determine the commonly used microphone based on selection of the user. In this way, in a plurality of microphone arrays corresponding to a same pose, an array that includes a largest quantity of commonly used microphones may be marked with the “commonly used” label. In some other examples, the electronic device may display an example distribution map of microphones on the electronic device in advance. During display of the example distribution map, the electronic device may further sequentially display microphone arrays that match different poses. In this case, the user may select a commonly used microphone array by tapping the display of the electronic device. Correspondingly, the electronic device may mark, with the “commonly used” label, the microphone array selected by the user.

In this way, the electronic device may select, by identifying the “commonly used” label, a microphone array with the “commonly used” label as the microphone array to be currently actually enabled from the plurality of matching microphone arrays.

For another example, the preset condition may further include an optimal sound pickup effect in a current environment. The sound pickup effect may be distinguished by using a sound effect score. The sound effect score may be a score given by an artificial intelligence model for collected sound data from perspectives of sound quality, volume, and the like.

In this way, the electronic device may sequentially enable all groups of matching microphone arrays to collect a sound in a short time, and then score, by using the artificial intelligence model, sound data collected by each group of microphone arrays, to determine a microphone array with the optimal sound pickup effect as the microphone array to be currently actually enabled.

For another example, the preset condition may further include that no microphone is blocked. In some examples, a vibration amplitude of a sound wave signal collected by a microphone may be compared with a preset value (an empirical value). If the vibration amplitude corresponding to the microphone is less than the preset value, and a vibration amplitude corresponding to another microphone is not less than the preset value, it is determined that the microphone is blocked.

In this way, the electronic device may first determine the blocked microphone, and then select a microphone array that includes no blocked microphone as the microphone array to be currently actually enabled from the matching microphone arrays.

In addition, there is further a case in which when the microphone array (for example, a microphone array 1) to be actually enabled is determined, the microphone array 1 includes no blocked microphone. During enabling of the microphone array 1, if a microphone in the microphone array 1 is blocked, a query for the microphone array that matches the current pose may be triggered again, and the microphone array to be actually enabled may be determined again.

In a second manner, the electronic device may determine an adapted microphone array based on a collection direction selected by the user.

In some embodiments, the electronic device may determine, based on an operation performed by the user on the display, the collection direction selected by the user. The collection direction may include left front, right front, left, right, straight ahead, or the like.

For example, the user may tap on the display, and the electronic device may determine the collection direction based on a direction between a tapped location and a pre-selected point.

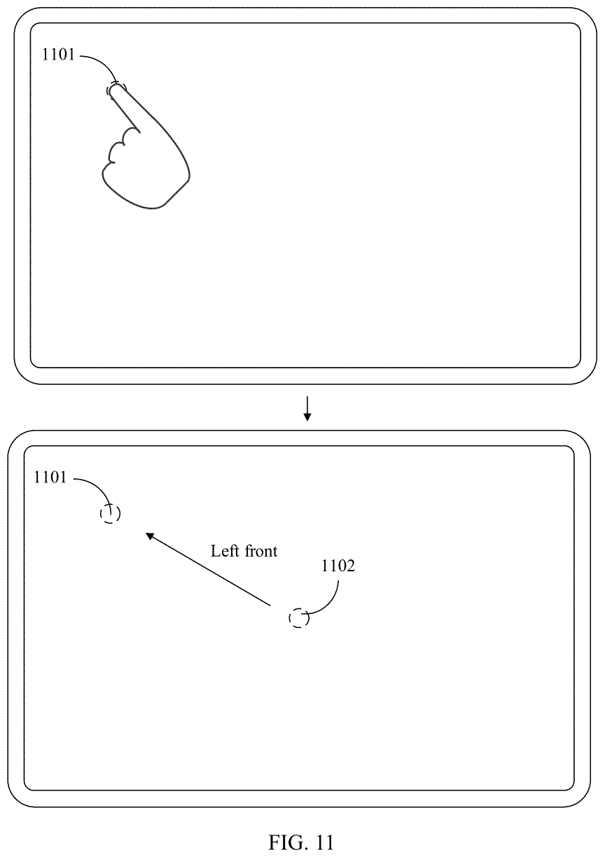

For example, when a center point of the display is configured as a fixed pre-selected point, as shown in FIG. 11, the user taps a location 1101 on the display, and the electronic device may identify that the location 1101 is a tapped location. In this case, a direction between the center point 1102 of the display and the location 1101 is left front, and the electronic device may determine that the collection direction is left front.

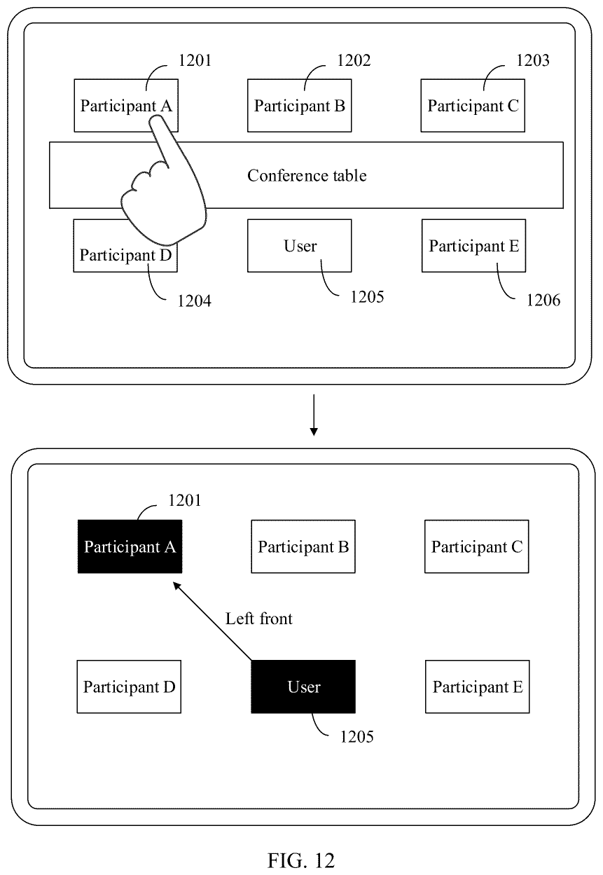

For another example, when the user participates in an offline conference, a conference service application may be enabled in the electronic device to record voice conference minutes. During enabling of the conference service application, as shown in FIG. 12, the electronic device may display a conference service interface. The conference service interface includes locations of a plurality of participants. For example, a location 1201 indicates a location of a participant A in a current conference scenario, a location 1202 indicates a location of a participant B in the current conference scenario, a location 1203 indicates a location of a participant C in the current conference scenario, a location 1204 indicates a location of a participant D in the current conference scenario, a location 1205 indicates a location of the user in the current conference scenario, and a location 1206 indicates a location of a participant E in the current conference scenario. The location of the user in the current conference scenario, that is, the location 1205, may be used as a pre-selected point.

In addition, location distribution of the participants in the conference service interface may be determined based on a seat template selected by the user, an entered quantity of participants, and the like. Alternatively, location distribution of the participants in the conference service interface may be generated based on a live photo of the current conference scenario. This is not limited in this embodiment of this application.

In the foregoing example, when it is detected that the user taps any participant location, a direction between the selected participant location and the location of the user may be used as the selected collection direction. For example, when it is detected that the user selects the location of the participant A, that is, the location 1201, and it is determined that a manner between the location 1201 and the location of the user (that is, the location 1205) is left front, left front may be determined as the collection direction.

After determining the collection direction, the electronic device may determine the adapted microphone array by looking up a table.

In an implementation, a correspondence table b between different collection directions and different microphone arrays may be preconfigured in the electronic device. For example, when the electronic device is the tablet computer shown in FIG. 1, and the tablet computer includes only three ADCs, the correspondence table b between the pose and the microphone array may be shown in Table 2 below:

TABLE 2

| Collection direction | Microphone array |
|---|---|
| Left front | Array combining the microphone a, the microphone |
| | b, and the microphone c |
| | Array combining a microphone e, a microphone f, |
| | and the microphone d |
| Right front | Array combining the microphone a, the microphone |
| | b, and the microphone d |
| | Array combining the microphone e, the microphone |
| | f, and the microphone c |
| Straight ahead | Array combining the microphone a and the |
| | microphone b |

It may be understood that Table 2 is merely an example of a correspondence, and may not be considered as a specific limitation on the correspondence table b in this embodiment of this application.

Certainly, in an actual application process, the correspondence table b may include more or updated collection directions. Microphone arrays corresponding to different collection directions are determined through pre-testing.

For example, a microphone array corresponding to left front is tested. A sound source is first placed in left front of the electronic device, and then different microphone arrays are enabled to collect sound data. Then, a sound pickup effect of each group of microphone arrays is evaluated based on the collected sound data, then a microphone array whose sound pickup effect has a higher ranking than a specified ranking is selected as the microphone array corresponding to left front, and the correspondence table b is created.

When the correspondence table b is configured in the electronic device, the electronic device may query, by using the comparison relationship table b, a microphone array that matches the collection direction selected by the user, and enable the microphone array. For example, on the basis of the collection direction selected by the user being straight ahead, it may be obtained, through query by using Table 2, that a matching microphone array includes the microphone a and the microphone b. In this case, the electronic device may use the matching microphone array as a microphone array that needs to be actually enabled. Currently, for a process of starting the microphone array, refer to the descriptions in the foregoing embodiment. Details are not described herein again.

In addition, in some special cases, for example, when a plurality of matching microphone arrays are obtained through query, one of the plurality of matching microphone arrays may be selected as the microphone array to be actually enabled. For a manner of selecting the microphone array to be actually enabled from the plurality of matching microphone arrays, refer to the descriptions in the foregoing embodiment. Details are not described herein again.

In a third manner, the electronic device may randomly select an adapted microphone array.

In some embodiments, an array list is configured in the electronic device, and all available microphone arrays are listed in the array list. The electronic device may select one microphone array from all the available microphone arrays based on the array list, and enable the microphone array. In an enabling process, a sound pickup effect of the microphone array is evaluated based on sound data collected by the microphone array. If the sound pickup effect of the microphone array is unqualified, for example, a score corresponding to the sound pickup effect is less than a specified score, the electronic device is triggered to reselect the adapted microphone array. The specified score may be an empirical value. This is not specifically limited herein. If the sound pickup effect of the microphone array is qualified, for example, a score corresponding to the sound pickup effect is not less than the specified score, the current microphone array continues to be used.

That the electronic device reselects the adapted microphone array may be: randomly selecting another microphone array from a microphone array that is not enabled, and enabling the newly selected microphone array. During enabling of the newly selected microphone array, a sound pickup effect corresponding to the microphone array continues to be repeatedly evaluated. If the sound pickup effect of the newly selected microphone array is also unqualified, the electronic device is also triggered to select the adapted microphone array again. If the sound pickup effect of the newly selected microphone array is qualified, the newly selected microphone array continues to be used.

In another possible embodiment, the electronic device may sequentially enable all groups of microphone arrays to collect sound data. Then, a sound pickup effect of the corresponding microphone array is evaluated by using the collected sound data. Then, a microphone array with a best sound pickup effect is selected as the adapted microphone array.

In a fourth manner, the electronic device may determine an adapted microphone array by using a machine learning model.

In an implementation, the machine learning model may be a model obtained through training based on historical use data of all microphone arrays. The historical use data may include system time, a positioning location, battery level information, corresponding pose information, and the like of the electronic device when the microphone array is used. In this way, the machine learning model obtained through training can obtain the adapted microphone array through evaluation from at least one dimension such as time, space, a battery level, and a pose.

In this way, during running, the electronic device may identify a current adapted microphone array by obtaining one or more of current system time, a positioning location, battery level information, and pose information and with reference to the machine learning model.

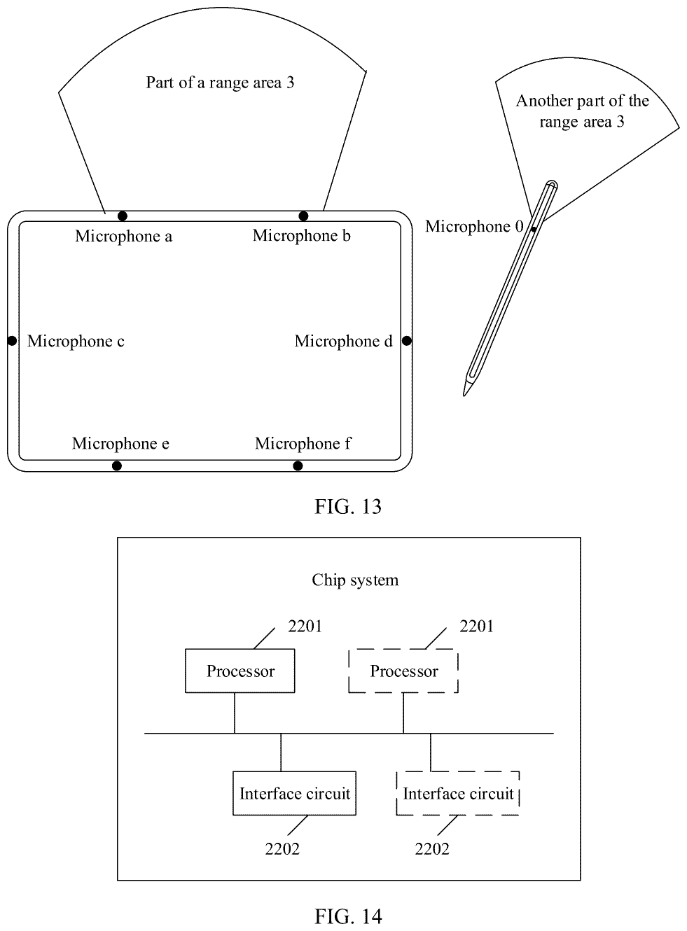

In some special scenarios, as shown in FIG. 13, when a stylus collaboratively works with the electronic device, that is, when a collaborative communication channel is established between the stylus and the electronic device, or when the stylus is connected to the electronic device, the electronic device may enable a microphone array including a microphone of the stylus. For example, as shown in FIG. 13, the microphone a, the microphone b, and the microphone 0 are enabled to collect a sound emitted by a sound source in a range area 3.

In an implementation, a correspondence table, for example, referred to as a correspondence table c, including the microphone of the third-party device is configured in the electronic device. The correspondence table c includes corresponding microphone arrays in different poses and different collection directions. Microphone arrays in the correspondence list c each include the microphone of the third-party device.

In this way, when detecting that the microphone of the third-party device is connected, the electronic device searches for a microphone array for a current video by using the correspondence list c, and enables the microphone array.

In conclusion, the electronic device provided in this embodiment of this application may adjust a microphone connected to each ADC. Then, a microphone currently connected to at least one ADC forms a microphone array, and the microphone array collects sound data. Certainly, the electronic device may enable different microphone arrays in different time periods. In this way, the electronic device may collect sound data in different range areas based on different scenario requirements. In addition, in a scenario in which the electronic device enables a sound pickup service, it is more likely to trigger switching of the enabled microphone array, for example, the scenario that is described in the foregoing embodiment and in which the conference service application is used, for another example, a scenario in which the user uses the electronic device to shoot a video, or for another example, a scenario in which the user uses the electronic device to record a classroom, a drama, or a large-scale stage play.

The microphone control method provided in the embodiments of this application is described below. The method is applied to an electronic device. For example, the electronic device includes a plurality of microphones, a first ADC, and a second ADC. An implementation process of the method is as follows:

S1: When the electronic device is in a first pose, enable a first array to collect first sound data.

The first array is a microphone array provided in the foregoing embodiment, and the first array includes at least a first microphone and a second microphone. There may be a correspondence between the first array and the first pose. For example, the electronic device includes a first list (the correspondence table a in the foregoing embodiment), and the first list records that the first array matches the first pose and also records that the second array matches a second pose.

In some embodiments, when the first array is started, a connection between the first microphone and the first ADC needs to be established, and a connection between the second microphone and the second ADC needs to be established. In this way, after analog to digital processing is performed by the first ADC, sound data collected by the first microphone may be sent to a digital codec for encoding, compression, and the like; and after analog to digital processing is performed by the second ADC, sound data collected by the second microphone may be sent to the digital codec for encoding, compression, and the like. In addition, sound data collected by a microphone in the first array may be referred to as the first sound data.

In addition, a connection manner between the ADC and the microphone may be a direct connection or an indirect connection. For example, a connection is established through a bias circuit, a data selection module, or another device.

S2: When the electronic device is in the second pose, enable the second array to collect second sound data.

The second array is also a microphone array, and the second array includes at least a third microphone and a fourth microphone. The first array and the second array include at least one different microphone. In this way, sound pickup ranges of the first array and the second array are different.

In some embodiments, a process in which the electronic device starts the second array includes: establishing a connection between the third microphone and the first ADC, and establishing a connection between the fourth microphone and the second ADC. In addition, sound data collected by a microphone in the second array may be referred to as the second sound data.

In some examples, the first pose is different from the second pose, and the electronic device may adjust an enabled microphone array based on different postures of the electronic device in space, to meet sound pickup requirements in different postures.

In some embodiments, when the electronic device switches from the first array to enable the second array, the method may further include: disconnecting the connection between the first microphone and the first ADC; and disconnecting the connection between the second microphone and the second ADC.

In this way, by disconnecting the connection between and establishing a new connection between the microphone and the ADC, a same ADC may be shared by a plurality of microphones, to ensure a normal sound pickup effect and remove a limitation of a quantity of ADCs on a quantity of connected microphones.

In addition, in some embodiments, before the enabling a first array to collect first sound data, the method further includes: collecting first pose information, where the first pose information indicates that the electronic device is in the first pose. The first pose information may be information determined based on data detected by a gravity sensor, an acceleration sensor, a gyroscope, or the like in the electronic device, and may indicate a posture of the device in an environment in which the device is located.

Similarly, before the enabling the second array to collect second sound data, the method further includes: collecting second pose information, where the second pose information indicates that the electronic device is in the second pose. The second pose information is similar to the first pose information, and a difference between the second pose information and the first pose information lies in different collection times.

In some embodiments, the method may further include the following steps.

S3: Receive a first operation performed by a user.

In some embodiments, the first operation may be an operation of selecting a microphone array, or may be an operation of indicating a direction.

In some scenarios, before a sound collection function needs to be enabled, for example, before the electronic device starts shooting video data or before a video call is connected, the electronic device may detect whether the user performs the first operation.

S4: In response to the first operation, switch to enable a third array to collect third sound data.

In some embodiments, the third array is also a microphone array, and the third array includes a fifth microphone and a sixth microphone. In addition, there is an association between the third array and the first operation.

For example, the first operation is an operation of selecting the third array by the user. In this way, there is an association between the first operation and the third array. In this example, the method further includes: displaying a first interface, where location distribution of all the microphones is displayed in the first interface. In this case, the user may tap the microphone in the first interface, and the selected microphone forms the third array. That is, during display of the first interface, the electronic device may detect a selection operation performed by the user on the microphone in the first interface. When the user selects the fifth microphone and the sixth microphone, it is determined that the first operation is received.

For another example, the first operation is an operation of indicating a first direction. When the foregoing correspondence table b indicates that there is a correspondence between the first direction and the third array, the first operation is related to the third array.

In addition, when the first operation is the operation of indicating the first direction, the first operation may be a sliding operation performed by the user on a display of the electronic device, and a sliding direction of the operation may be the first direction.

When the first operation is the operation of indicating the first direction, the first operation may alternatively be an operation of selecting a location point on the display by the user, and the first direction is a direction corresponding to the selected location point.

For example, the electronic device may display a second interface, where the second interface is an application interface of a conference service application, and the second interface includes a location distribution map of participants; and when it is detected that the user selects a first participant in the second interface and a direction between the first participant and the user is the first direction, determine that the first operation is received.

In addition, for a manner of starting the third array, refer to starting of the first array or the second array described in the foregoing embodiment. Details are not described herein again. After the third array is enabled, sound data collected by a microphone in the third array may be collectively referred to as the third sound data.

In some other embodiments, the method further includes the following steps.

S5: Detect that a communication connection to a stylus is established.

S6: Switch to enable a fourth array to collect fourth sound data.

The fourth array is also a microphone array. A difference is that the fourth array includes a microphone of the stylus, and certainly, may further include a microphone, for example, a seventh microphone, configured in the electronic device. In this way, a plurality of devices may coordinate to pick up a sound, so as to improve a sound pickup effect.

In addition, for a manner of starting the fourth array, refer to starting of the first array or the second array described in the foregoing embodiment. Details are not described herein again. After the fourth array is enabled, sound data collected by a microphone in the fourth array may be collectively referred to as the fourth sound data.

In another embodiment, a first model is configured in the electronic device, the first model is a machine learning model used to identify a matching microphone array, and the method further includes: obtaining current scenario information, where the scenario information includes one or a combination of system time, a positioning location, a device battery level, and pose information; inputting the current scenario information to the first model, to determine a fifth array; and enabling the fifth array to collect fifth sound data.

In addition, for a manner of starting the fifth array, refer to starting of the first array or the second array described in the foregoing embodiment. Details are not described herein again. After the fifth array is enabled, sound data collected by a microphone in the fifth array may be collectively referred to as the fifth sound data.

An embodiment of this application further provides an electronic device. The electronic device may include a memory and one or more processors. The memory is coupled to the processor. The memory is configured to store computer program code, and the computer program code includes computer instructions. When the processor executes the computer instructions, the electronic device may be enabled to perform the steps in the foregoing embodiments. Certainly, the electronic device includes but is not limited to the memory and the one or more processors.

An embodiment of this application further provides a chip system, and the chip system may be applied to the terminal device in the foregoing embodiments. As shown in FIG. 14, the chip system includes at least one processor 2201 and at least one interface circuit 2202. The processor 2201 may be the processor in the foregoing electronic device. The processor 2201 and the interface circuit 2202 may be connected to each other through a line. The processor 2201 may receive computer instructions from the memory of the foregoing electronic device through the interface circuit 2202, and execute the computer instructions. When the computer instructions are executed by the processor 2201, the electronic device may be enabled to perform the steps in the foregoing embodiments. Certainly, the chip system may further include another discrete device. This is not specifically limited in this embodiment of this application.

In some embodiments, it may be clearly understood by a person skilled in the art through descriptions of the foregoing implementations that for ease and brevity of description, division of the foregoing functional modules is merely used as an example for description. In actual applications, the foregoing functions may be allocated to different functional modules for completion based on a requirement, that is, an internal structure of the apparatus is divided into different functional modules to complete all or some of the functions described above. For specific working processes of the system, apparatus, and unit described above, refer to corresponding processes in the method embodiments. Details are not described herein again.

In the embodiments of this application, functional units in the embodiments may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of the embodiments of this application essentially, or the part contributing to the conventional technology, or all or some of the technical solutions may be implemented in a form of a software product. The computer software product is stored in a storage medium and includes several instructions for instructing a computer device (which may be a personal computer, a server, a network device, or the like) or a processor to perform all or some of the steps of the methods described in the embodiments of this application. The storage medium includes any medium that can store program code, for example, a flash memory, a removable hard disk, a read-only memory, a random access memory, a magnetic disk, or an optical disc.

The foregoing descriptions are merely specific implementations of the embodiments of this application, but are not intended to limit the protection scope of the embodiments of this application. Any variation or replacement within the technical scope disclosed in the embodiments of this application shall fall within the protection scope of the embodiments of this application. Therefore, the protection scope of the embodiments of this application shall be subject to the protection scope of the claims.

1. A microphone control method, applied to an electronic device, wherein the electronic device comprises a plurality of microphones, a first analog to digital converter, and a second analog to digital converter, wherein the plurality of microphones plurality of microphones comprises a first microphone, a second microphone, a third microphone and a fourth microphone, and the method comprises:
when the electronic device is in a first pose, enabling a first array to collect first sound data, wherein the first array comprises the first microphone and the second microphone; and the enabling the first array comprises: establishing a connection between the first microphone and the first analog to digital converter, and establishing a connection between the second microphone and the second analog to digital converter; and
when the electronic device is in a second pose, enabling a second array to collect second sound data, wherein the second array comprises the third microphone and the fourth microphone; the enabling the second array comprises: establishing a connection between the third microphone and the first analog to digital converter, and establishing a connection between the fourth microphone and the second analog to digital converter; and the first pose is different from the second pose.

2. The method according to claim 1, wherein before the enabling the second array, the method further comprises:
disconnecting the connection between the first microphone and the first analog to digital converter; and
disconnecting the connection between the second microphone and the second analog to digital converter.

3. The method according to claim 1, wherein before the enabling a first array to collect first sound data, the method further comprises:
collecting first pose information, wherein the first pose information indicates that the electronic device is in the first pose; and
before the enabling a second array to collect second sound data, the method further comprises:
collecting second pose information, wherein the second pose information indicates that the electronic device is in the second pose.

4. The method according to claim 1, wherein the plurality of microphones plurality of microphones further comprises a fifth microphone and a sixth microphone, the method further comprises:
receiving a first operation performed by a user; and
in response to the first operation, switching to enable a third array to collect third sound data, wherein the third array comprises the fifth microphone and the sixth microphone.

5. The method according to claim 4, wherein the first operation comprises an operation of selecting the third array by the user, and before the receiving a first operation performed by a user, the method further comprises:
displaying a first interface, wherein location distribution of the plurality of microphones is displayed in the first interface; and
detecting a selection operation performed by the user on the microphone in the first interface;
wherein when the user selects the fifth microphone and the sixth microphone, it is determined that the first operation is received.

6. The method according to claim 4, wherein the first operation is an operation of indicating a first direction, and in the electronic device, there is a correspondence between the third array and the first direction.

7. The method according to claim 6, wherein before the receiving a first operation performed by a user, the method comprises:
displaying a second interface, wherein the second interface is an application interface of a conference service application, and the second interface comprises a location distribution map of participants; and
when it is detected that the user selects a first participant in the second interface and a direction between the first participant and the user is the first direction, determining that the first operation is received.

8. The method according to claim 1, wherein the plurality of microphones plurality of microphones further comprises a seventh microphone, the method further comprises:
detecting that a communication connection to a stylus is established; and
switching to enable a fourth array to collect fourth sound data, wherein the fourth array comprises the seventh microphone and a microphone configured on the stylus.

9. The method according to claim 1, wherein a first model is configured in the electronic device, the first model is a machine learning model used to identify a matching microphone array, and the method further comprises:
obtaining current scenario information, wherein the scenario information comprises one or a combination of system time, a positioning location, a device battery level, and pose information;
inputting the current scenario information to the first model, to determine a fifth array; and
enabling the fifth array to collect fifth sound data.

10. The method according to claim 1, wherein the electronic device comprises a first list, and the first list records that the first array matches the first pose and also records that the second array matches the second pose.

11. An electronic device, wherein the electronic device comprises a plurality of microphones, a first analog to digital converter, and a second analog to digital converter, one or more processors and a memory, wherein the plurality of microphones plurality of microphones comprises a first microphone, a second microphone, a third microphone and a fourth microphone, the memory is coupled to the processor, the memory is configured to store computer program code, the computer program code comprises computer instructions, and when the one or more processors execute the computer instructions, the one or more processors are configured to perform the method comprising:
when the electronic device is in a first pose, enabling a first array to collect first sound data, wherein the first array comprises the first microphone and the second microphone; and the enabling the first array comprises: establishing a connection between the first microphone and the first analog to digital converter, and establishing a connection between the second microphone and the second analog to digital converter; and
when the electronic device is in a second pose, enabling a second array to collect second sound data, wherein the second array comprises the third microphone and the fourth microphone; the enabling the second array comprises: establishing a connection between the third microphone and the first analog to digital converter, and establishing a connection between the fourth microphone and the second analog to digital converter; and the first pose is different from the second pose.

12. A computer storage medium, comprising computer instructions, wherein when the computer instructions are run on an electronic device, the electronic device comprises a plurality of microphones, a first analog to digital converter, and a second analog to digital converter, wherein the plurality of microphones plurality of microphones comprises a first microphone, a second microphone, a third microphone and a fourth microphone, the electronic device is enabled to perform the method comprising:
when the electronic device is in a first pose, enabling a first array to collect first sound data, wherein the first array comprises the first microphone and the second microphone; and the enabling the first array comprises: establishing a connection between the first microphone and the first analog to digital converter, and establishing a connection between the second microphone and the second analog to digital converter; and
when the electronic device is in a second pose, enabling a second array to collect second sound data, wherein the second array comprises the third microphone and the fourth microphone; the enabling the second array comprises: establishing a connection between the third microphone and the first analog to digital converter, and establishing a connection between the fourth microphone and the second analog to digital converter; and the first pose is different from the second pose.

13. (canceled)

14. The method according to claim 1, wherein the electronic device further comprises a first data selection module, a second data selection module and a digital codec, wherein the digital codec is connected to the first analog to digital converter and the second analog to digital converter, the first analog to digital converter is connected to the first microphone or the third microphone through the first data selection module, the second analog to digital converter is connected to the second microphone or the fourth microphone through the second data selection module.

15. The method according to claim 14, wherein establishing a connection between the first microphone and the first analog to digital converter through the first data selection module, and establishing a connection between the second microphone and the second analog to digital converter through the second data selection module.

16. The method according to claim 14, wherein the enabling the second array comprises: establishing a connection between the third microphone and the first analog to digital converter through the first data selection module, and establishing a connection between the fourth microphone and the second analog to digital converter through the second data selection module.

17. The method according to claim 2, wherein before the enabling a first array to collect first sound data, the method further comprises:
collecting first pose information, wherein the first pose information indicates that the electronic device is in the first pose; and
before the enabling a second array to collect second sound data, the method further comprises:
collecting second pose information, wherein the second pose information indicates that the electronic device is in the second pose.

18. The method according to claim 2, wherein the method further comprises:
receiving a first operation performed by a user; and
in response to the first operation, switching to enable a third array to collect third sound data, wherein the third array comprises a fifth microphone and a sixth microphone in the plurality of microphones.

19. The electronic device according to claim 11, the electronic device further comprises a first data selection module, a second data selection module and a digital codec, wherein the digital codec is connected to the first analog to digital converter and the second analog to digital converter, the first analog to digital converter is connected to the first microphone or the third microphone through the first data selection module, the second analog to digital converter is connected to the second microphone or the fourth microphone through the second data selection module.

20. The electronic device according to claim 19, wherein establishing a connection between the first microphone and the first analog to digital converter through the first data selection module, and establishing a connection between the second microphone and the second analog to digital converter through the second data selection module.

21. The electronic device according to claim 19, wherein the enabling the second array comprises: establishing a connection between the third microphone and the first analog to digital converter through the first data selection module, and establishing a connection between the fourth microphone and the second analog to digital converter through the second data selection module.
